(19) United States
(12) Patent Application Publication
(10) Pub. No.: US 2025/0164771 A1
(43) Pub. Date: May 22, 2025

(54) High-speed, high-resolution optical system for large-field-of-view optical system for live tissue functional imaging

(71) Applicants: The Board of Trustees of the Leland Stanford Junior University, Stanford, CA (US); Howard Hughes Medical Institute, Chevy Chase, MD (US)

(72) Inventors: Radoslaw Chrapkiewicz, Sunnyvale, CA (US); Mark J. Schnitzer, Stanford, CA (US)

(21) Appl. No.: 19/032,096

(22) Filed: Jan. 19, 2025

Related U.S. Application Data
(63) Continuation-in-part of application No. 18/943,818, filed on Nov. 11, 2024.
Application No. 18/943,818 is a continuation-in-part of application No. 18/749,313, filed on Jun. 20, 2024.
(60) Provisional application No. 63/522,044, filed on Jun. 20, 2023.
(60) Provisional application No. 63/718,783, filed on Nov. 11, 2024.
(60) Provisional application No. 63/598,081, filed on Nov. 11, 2023.

(51) Int. Cl. G02B 21/16; G02B 21/02; H04N 23/13; H04N 23/74; H04N 25/531; H04N 25/532; H04N 25/76

(52) U.S. Cl. CPC G02B 21/16; G02B 21/02; H04N 23/13; H04N 23/74; H04N 25/531; H04N 25/532; H04N 25/76

(57) ABSTRACT

The present invention provides a microscopy imaging system with high spatial and temporal resolution and large field of view. One embodiment provides a combination of large field-of-view (8 mm) with high numerical aperture (0.47), superior temporal resolution (up to 1000 Hz) while maintaining high spatial resolution (i.e., less than 6 μm), dual-channel synchronized imaging capability, enhanced light collection efficiency (˜85% transmission), and LED synchronization with rolling shutter mechanism of the sCMOS cameras.

### CROSS-REFERENCE TO RELATED APPLICATIONS

This application is a continuation-in-part of U.S. patent application Ser. No. 18/943,818 filed Nov. 11, 2024, which claims priority from U.S. Provisional Patent Application 63/718,783 filed Nov. 11, 2024 and from U.S. Provisional Patent Application 63/598,081 filed Nov. 11, 2023, which are incorporated herein by reference. U.S. patent application Ser. No. 18/943,818 is a continuation-in-part of U.S. patent application Ser. No. 18/749,313 filed Jun. 20, 2024, which claims priority from U.S. Provisional Patent Application 63/522,044 filed Jun. 20, 2023, both of which are incorporated herein by reference.

### STATEMENT OF FEDERALLY SPONSORED RESEARCH

None.

### FIELD OF THE INVENTION

The present invention relates generally to optical instruments. More specifically it relates to high speed, high resolution fluorescence microscopy.

### BACKGROUND OF THE INVENTION

Modern neuroscience demands simultaneous observation of multiple neural signaling modalities across large brain areas, including voltage dynamics, calcium transients, neuromodulator release, and intrinsic signals. Traditional microscopy systems fundamentally fail to meet these demands due to inherent trade-offs between field of view, resolution, and imaging speed. This limitation becomes particularly acute in voltage imaging applications, where detection of minute fluorescence changes requires exceptional signal-to-noise ratios while maintaining high temporal resolution across the entire field. When attempting to combine multiple imaging modalities, such as simultaneous voltage and calcium imaging or concurrent monitoring of different neuromodulators, these limitations compound significantly. The challenge intensifies with the need to excite and detect signals from spectrally diverse fluorophores and dyes, each requiring precise illumination timing and specific detection parameters. Current systems cannot effectively manage the complex synchronization required between multiple excitation sources and rolling shutter detectors, leading to compromised signal quality and temporal resolution. Furthermore, attempting to switch between different imaging modalities or combine them introduces additional technical barriers, as traditional optical designs struggle with vignetting, numerical aperture limitations, and inadequate photon collection efficiency across large fields. These limitations have effectively prevented researchers from simultaneously monitoring multiple aspects of neural function across behaviorally relevant brain areas with sufficient spatial and temporal resolution.

Modern biomedical imaging frequently employs complementary metal-oxide-semiconductor (CMOS) sensors operating with rolling shutter mechanisms due to their high frame rates, low cost, and large sensor formats. In rolling shutter mechanisms, different rows of the sensor are exposed and read out sequentially rather than simultaneously. This sequential exposure can introduce challenges when using pulsed or modulated light sources, as the temporal difference between the exposure of the first and last rows can result in artificial spatiotemporal variations, such as intensity gradients or stripes across the image. These artifacts degrade image quality and limit the effectiveness of imaging techniques, particularly in high-speed or multi-spectral imaging applications.

When a pulsed light source is employed-simply turning the light on and off—this results in a spatiotemporal pattern, such as an artificial linear gradient of light intensity across the entire frame or distinct stripes. This effect becomes a significant limitation when employing multiple excitation sources, such as different LEDs, lasers, or other light sources that are filtered and possess overlapping or non-overlapping spectral bands. The challenge is exacerbated in multi-spectral fluorescence imaging, where distinguishing between various biological specimens labeled with different fluorophores is essential.

Methods for creating multiple excitation channels with single or multiple cameras in fluorescence imaging often rely on CMOS sensors with rolling shutter mechanisms. Utilizing multiple excitation bands, even with a single camera, offers the advantage of distinguishing between various biological specimens, particularly when different fluorophores label different cell types, such as neurons and other cells. By using distinct spectral bands for excitation alone, even with a single camera equipped with a broad emission filter, it becomes possible to discriminate between different fluorophores based on variations in the images.

The combination of multiple excitation sources and multiple cameras allows for an expanded number of imaging channels, especially when there is a significant difference between the emission or excitation bands of the employed fluorophores. However, conventional approaches to multi-spectral imaging often face limitations in achieving both high frame rates and efficient light utilization. Traditional epifluorescence microscopy typically uses one or two excitation sources with corresponding cameras, limiting the ability to image multiple fluorophores simultaneously at high speeds without compromising signal quality.

Moreover, the use of rolling shutter mechanisms introduces additional challenges when synchronizing illumination with sensor exposure. Artificial spatiotemporal variations can arise, leading to undesirable effects such as intensity gradients or stripes across the image. This issue becomes particularly challenging when implementing multiple excitation sources for multi-spectral imaging.

There is a need for an imaging system that can provide high-speed multi-spectral imaging using rolling shutter CMOS sensors while eliminating the spatiotemporal artifacts associated with rolling shutter operation. Such a system would enable researchers to image dynamic biological processes with high temporal resolution while discriminating between multiple fluorescent labels.

### SUMMARY OF THE INVENTION

The present invention provides an optical imaging microscopy system with high resolution and large field of view referred herein as a mesoscope system.

In one aspect, the invention provides a fluorescence microscopy system utilizing CMOS sensors with synchronized multi-channel illumination in rolling shutter-based imaging applications, enabling high-speed multi-spectral imaging while eliminating spatiotemporal artifacts associated with rolling shutter operation.

Embodiments are capable of providing an unprecedented combination of large field-of-view (e.g., 8 mm) with high numerical aperture (e.g., 0.47), superior temporal resolution (up to 1000 Hz) while maintaining spatial resolution, dual-channel synchronized imaging capability, enhanced light collection efficiency (e.g., ˜85% transmission), and LED synchronization with rolling shutter mechanism of the sCMOS cameras.

The mesoscope system improves multi-modal neural imaging by enabling simultaneous monitoring of diverse neural signals across large brain regions. The system employs specialized high numerical aperture (0.47 NA) photographic lenses that maintain exceptional light collection efficiency across an unprecedented 8 mm field-of-view, enabling detection of subtle voltage indicators, bright calcium sensors, and diverse neuromodulator indicators simultaneously. The system's illumination architecture precisely coordinates multiple LED sources with rolling shutter operation, allowing for optimal excitation of spectrally distinct fluorophores without cross-talk or temporal artifacts. This synchronization enables seamless switching between imaging modalities or simultaneous multi-modal imaging, such as concurrent voltage and calcium imaging or combined neuromodulator and intrinsic signal detection. The dual-channel detection pathway, built around high-performance sCMOS cameras, provides flexibility in experimental design, allowing researchers to mix and match different combinations of indicators while maintaining high temporal resolution (up to 1000 Hz) and spatial resolution (below 15 μm, and preferably approximately 5 μm) across the entire field. The system's integrated control and data handling architecture manages the high-bandwidth data streams generated during multi-modal imaging, enabling real-time signal processing and storage of complex datasets. Through careful optimization of electron well capacity, magnification, and light collection efficiency, the system achieves the signal-to-noise ratios necessary for detecting minute fluorescence changes in voltage indicators while simultaneously capturing slower calcium dynamics or neuromodulator signals. This combination of features enables unprecedented experimental paradigms, such as studying the relationship between voltage dynamics and neurotransmitter release across entire cortical regions or monitoring calcium activity and intrinsic signals simultaneously during complex behaviors.

The present technique for synchronization of illumination with rolling shutter mechanisms enables high-speed multi-spectral imaging with multiple excitation sources and single or multiple cameras. It addresses the specific challenges associated with maintaining consistent illumination energy and signal-to-noise ratios across different spectral channels in multi-spectral fluorescence imaging.

The present invention provides systems and methods for synchronized multi-channel illumination in rolling shutter-based imaging applications. The invention enables high-speed multi-spectral imaging while maintaining uniform illumination patterns and maximizing light utilization efficiency. By precisely synchronizing pulsed excitation light sources with the rolling shutter exposure of CMOS sensors, the invention eliminates spatiotemporal artifacts and allows for the discrimination of different fluorophores using multiple excitation sources and single or multiple cameras.

In one aspect, the invention provides a synchronization mechanism that coordinates pulsed light sources with the rolling shutter operation of CMOS sensors. This coordination is achieved by generating a logical signal corresponding to the temporal overlap of the exposure of the first and last sensor rows within each frame. The result of this logical signal is then routed to drive an LED or another pulsed light source, allowing for a stationary pattern on the camera without spatial variations.

In another aspect, logic circuitry is introduced to count pulses and activate different light sources based on pulse counts. This configuration supports high-speed and multi-spectral acquisition, where the number of spectral bands is theoretically unlimited but effectively subsamples the frame rate for multi-spectral imaging.

Furthermore, the invention provides methods to maintain consistent signal-to-noise ratios by managing light energy delivery. By adjusting the pulse intensity and duration of the pulsed light sources, the system ensures that the energy delivered per frame remains consistent with continuous wave (CW) illumination, preserving image quality while maximizing imaging speed.

In one aspect, the invention provides an imaging system for fluorescence microscopy, comprising: a) an optical illumination system with one or multiple light sources, configured to provide illumination across distinct spectral bands; b) an objective lens with a numerical aperture of at least 0.2, providing a minimum field of view of 5 mm and a lateral optical resolution of 15 micrometers or better, configured to transmit the illumination to a specimen plane and detect fluorescence signals; and c) an optical image detection system with one or multiple cameras, each configured to capture images of the fluorescence signals at an acquisition speed of at least 5 Hz.

The imaging system may include an optical transmission system having two dichroic mirrors; wherein the optical illumination system is configured to illuminate a specimen with light pulses of distinct wavelength bands; wherein the objective lens is configured to transmit the light pulses and collect spectrally distinct fluorescent light from the specimen; wherein the optical image detection system has sCMOS cameras with rolling shutters synchronized with the light pulses to detect the spectrally distinct fluorescent light, wherein the light pulses and rolling shutters operate at a frequency of at least 5 Hz; and further comprising an integrated control and data handling system configured to collect, analyze, and store data streams generated from the sCMOS cameras.

The two dichroic mirrors may comprise a dual-band dichroic mirror that reflects the light pulses into the objective lens and a short-pass dichroic mirror that splits the spectrally distinct fluorescent light to propagate to the sCMOS cameras. The two dichroic mirrors preferably have a flatness of at most 4λ peak-to-valley wavefront error at a predetermined operational wavelength λ, have substrates with a thickness of at least 2 mm, have wavefront distortion of less than 1λ across the surface, have dimensions of at least 50 mm×70 mm, and have coatings for wavelength-specific reflection and transmission.

The sCMOS cameras preferably have a minimum sensor resolution of 4 MPx, a minimum frame rate of 80 fps at 4 MPx, a well capacity of at least 5000 electrons per pixel, and a read noise of 15 electrons or less.

The integrated control and data handling system may include an FPGA generating trigger pulses synchronizing the rolling shutters of the multiple sCMOS cameras with the light pulses from the LEDs with a precision of at least 10 μs.

Preferably, the light pulses are synchronized with a global exposure of the sCMOS cameras, where all the rows are imaged simultaneously.

The integrated control and data handling system preferably is configured to save data on hard drives or to RAM at a rate of at least 800 Mb/s.

The one or multiple cameras are preferably scientific-grade CMOS (sCMOS) cameras with a maximum readout noise of 8 electrons, a minimum acquisition rate of 30 Hz per 2000 rows, and a quantum efficiency of at least 60% at a central wavelength of an imaged fluorophore.

The optical image detection system may include multiple tube lenses, each with focal lengths in the range of 70-135 mm, an f-number less than 5.6, or more preferably 1.2, and configured to provide independent focus adjustment for the cameras.

The objective lens preferably provides a spatial precision of 15 μm or less across the minimum field of view, has a maximum aperture f-number of 1.2 or less, a focal length of at most 55 mm, and is designed to work with 35 mm films and full-size digital camera sensors while providing a working distance or flange focal distance of at least 2 mm.

The imaging system may include a focusing system comprising an ultrasound motor for focus adjustments, wherein the ultrasound motor integrates with photographic lens drivers, offering multiple speed modes and differential focusing. The focusing mechanism preferably includes ultrasound motors.

The imaging system may include a rotational stage configured to allow tilting of the imaging system.

In another aspect, the invention provides a system for synchronized multi-spectral imaging comprising: a) at least one CMOS camera operating with a rolling shutter mechanism; b) pulsed light sources emitting at different excitation wavelengths; c) control circuitry generating a synchronization signal based on a temporal overlap of an exposure of first and last camera sensor rows, wherein the synchronization signal is used to trigger the pulsed light sources; d) a module configured to sequentially activate the pulsed light sources based on pulse counts or predefined sequences; and e) spectral filters configured to separate excitation and emission wavelengths; whereby the system enables multi-spectral imaging at a frame rate of at least 100 Hz for 2048 camera rows acquisition while eliminating spatiotemporal artifacts associated with rolling shutter operation.

The control circuitry preferably comprises a logical AND gate combining exposure signals from the first and last sensor rows to generate the synchronization signal. The control circuitry preferably includes pulse counting mechanisms to control an activation sequence of the multiple light sources.

The pulsed light sources are preferably LEDs or lasers capable of less than 5 ms rise and fall times and adjustable pulse durations. An energy delivered per frame by each of the pulsed light sources may be maintained equivalent to continuous wave illumination by adjusting pulse power and duration.

The system may include multiple CMOS cameras, each with independent exposure control and dedicated spectral emission filters, synchronized to capture different spectral channels simultaneously.

The system may include a synchronization mechanism configured to ensure that illumination occurs only during a time when all camera sensor rows are exposed simultaneously, thereby eliminating spatial gradients or banding artifacts.

The system may include a control module configured to adjust individual light source power levels while maintaining synchronization, to account for differences in fluorophore brightness and spectral efficiency.

The control circuitry preferably includes programmable logic devices or microcontrollers configured to implement variable pulse counting and spectral imaging sequences.

### BRIEF DESCRIPTION OF THE DRAWINGS

FIG. 1 is a schematic diagram showing main components within an imaging system according to an embodiment of the invention.

FIG. 2 is a schematic diagram showing submodules within an imaging system and their interconnections, according to an embodiment of the invention.

FIG. 3A is a schematic diagram showing a dual-channel embodiment of the invention.

FIG. 3B is a schematic diagram showing a simplified single-channel embodiment of the invention.

FIG. 4 is a perspective view of an embodiment of the invention.

FIG. 5 is a schematic illustration of various controllers within an imaging system, according to an embodiment of the invention.

FIG. 6 is a schematic view of an embodiment of the invention illustrating the signal flow and connectivity among system components.

FIG. 7 is a schematic diagram showing a software architecture that governs the operation of an apparatus according to an embodiment of the invention.

FIG. 8 presents timing diagrams for different operational modes involving two cameras and their synchronization, according to an embodiment of the invention.

FIG. 9 illustrates the core logic used for synchronizing dual-camera operations through an FPGA or microprocessor unit, according to an embodiment of the invention.

FIG. 10 shows various fields of view attainable with the described imaging system.

FIG. 11 is a graph illustrating the strategic placement of excitation and emission bands in relation to the spectral properties of a genetically encoded voltage indicator (GEVI) and a reference signal, according to an embodiment of the invention.

FIG. 12 are graphs showing the characteristics of different mesoscope system families and highlights a specific embodiment of the invention.

FIG. 13 illustrates low-noise operation in an embodiment of the invention.

FIG. 14 is a flow diagram that outlines the procedural setup for imaging operations involving three channels using an alternating LED scheme, according to an embodiment of the invention.

FIG. 15 shows perspective views of a holder for various optical elements according to an embodiment of the invention.

FIG. 16 shows to graphs illustrating the resolution measurements of an imaging system according to an embodiment of the invention.

FIG. 17 is a perspective view illustrating an objective lens holder assembly according to an embodiment of the invention.

FIG. 18 is a perspective view illustrating an embodiment of the invention mounted on an optical table and supported by a heavy-duty rotary table.

FIG. 19 shows raw imaging data of 1-micron diameter beads as captured by the camera sensor, according to an embodiment of the invention.

FIG. 20 shows example images of a mouse brain slice.

FIG. 21 shows coronal slices imaged at 1 kHz acquisition speed.

FIG. 22 shows additional examples of coronal brain slices illustrating various brain regions with excitatory and inhibitory cells.

FIG. 23A and FIG. 23B shows cross-sectional and perspective views, respectively, of a mechanical design of a lens holder, according to an embodiment of the invention.

### DETAILED DESCRIPTION OF THE INVENTION

A system for synchronized multi-channel illumination in rolling shutter-based imaging applications are disclosed. The system enables high-speed multi-spectral imaging using CMOS sensors with rolling shutter mechanisms while eliminating spatiotemporal artifacts associated with rolling shutter operation. The system includes one or more CMOS cameras, multiple pulsed excitation light sources, control circuitry for synchronization, and spectral filters. The synchronization mechanism generates a logical signal based on the temporal overlap of the exposure of the first and last sensor rows, triggering the pulsed light sources during the period when all rows are exposed simultaneously. By adjusting the pulse intensity and duration, the system maintains consistent illumination energy per frame, preserving image quality. The system supports configurations with single or multiple cameras and allows for discrimination between different fluorophores based on variations in excitation patterns, providing an efficient solution for high-speed multi-spectral imaging in fluorescence microscopy.

The system provides an efficient solution for high-speed multi-spectral imaging using rolling shutter CMOS sensors. By synchronizing pulsed illumination with the concurrent exposure period of the sensor and adaptively controlling the pulse parameters, the system eliminates spatial artifacts while maximizing imaging speed and minimizing illumination crosstalk. The flexibility of the approach allows it to be adapted to various imaging configurations and applications, from single-camera multi-color imaging to multi-camera hyperspectral imaging. This technology has the potential to greatly enhance the capabilities of biomedical imaging and enable new scientific discoveries by providing high-speed, high-resolution, and multi-spectral imaging of living systems.

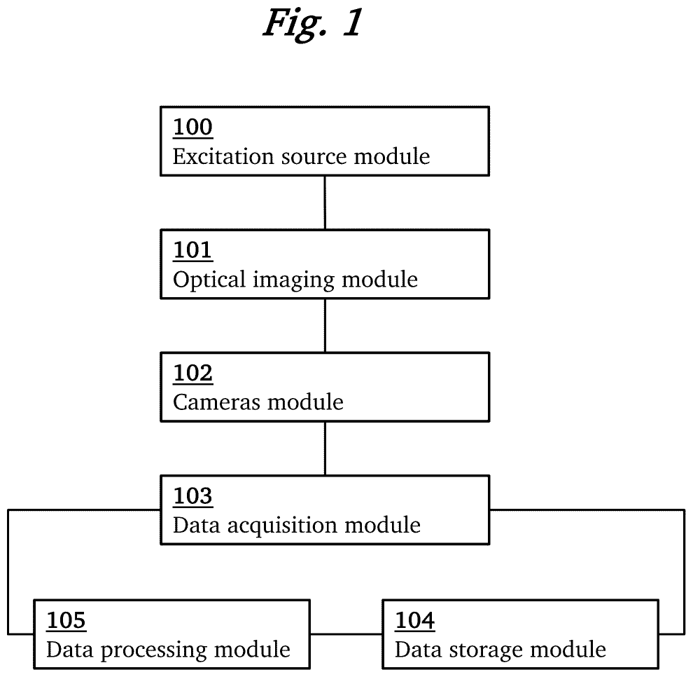

FIG. 1 illustrates the modular configuration and interrelationship of the main components within an imaging system according to one embodiment, detailing the process from excitation to data processing.

The excitation source module 100 includes multiple light sources such as lasers or high-intensity light-emitting diodes (LEDs) equipped with precise driver circuits for pulsed or continuous emission at distinct wavelengths targeting specific fluorophores, enabling versatile multi-spectral imaging. The excitation light sources preferably have fast (i.e. less than 5 ms) rise and fall times and are capable of short pulse durations to maximize imaging speed. Embodiments may also include control circuitry for synchronization, which includes logic to generate a synchronization signal indicating the temporal overlap of the exposure of the first and last sensor rows. This circuitry may involve logical AND operations and pulse counting mechanisms to control the activation sequence of the light sources.

The optical imaging module 101 comprises the optical pathway with dichroic mirrors, bandpass filters, and high numerical aperture lenses that direct excitation light to the specimen and collect emitted fluorescence, ensuring minimal optical aberrations and uniform illumination across the field of view. Embodiments may include spectral filters for separating the excitation and emission wavelengths and minimizing crosstalk between channels. For single-camera operation, a broad multi-bandpass emission filter can be used. For multi-camera setups, each camera can have dedicated emission filters.

The cameras module 102 integrates one or multiple scientific-grade CMOS cameras known for high sensitivity, low noise, and rolling shutter mechanisms to capture high-resolution images at substantial frame rates, converting photons into electronic signals for further processing. The cameras can be monochrome or color and preferably have sufficiently high frame rates and sensitivity for the desired application.

The data acquisition module 103 interfaces with the cameras, digitizing incoming signals into data streams synchronized with excitation pulses, employing hardware such as frame grabbers to manage high data throughput.

The data storage module 104 comprises computer controllers and a range of storage devices, including storage arrays, SSDs, and HDDs, for secure, efficient data handling, ensuring quick access for subsequent analysis.

The data processing module 105 provides real-time visualization and analysis using advanced algorithms for noise reduction, signal extraction, and fluorescence quantification, supporting calcium signal analysis, voltage imaging, and spike detection, and offering immediate feedback for experimental optimization.

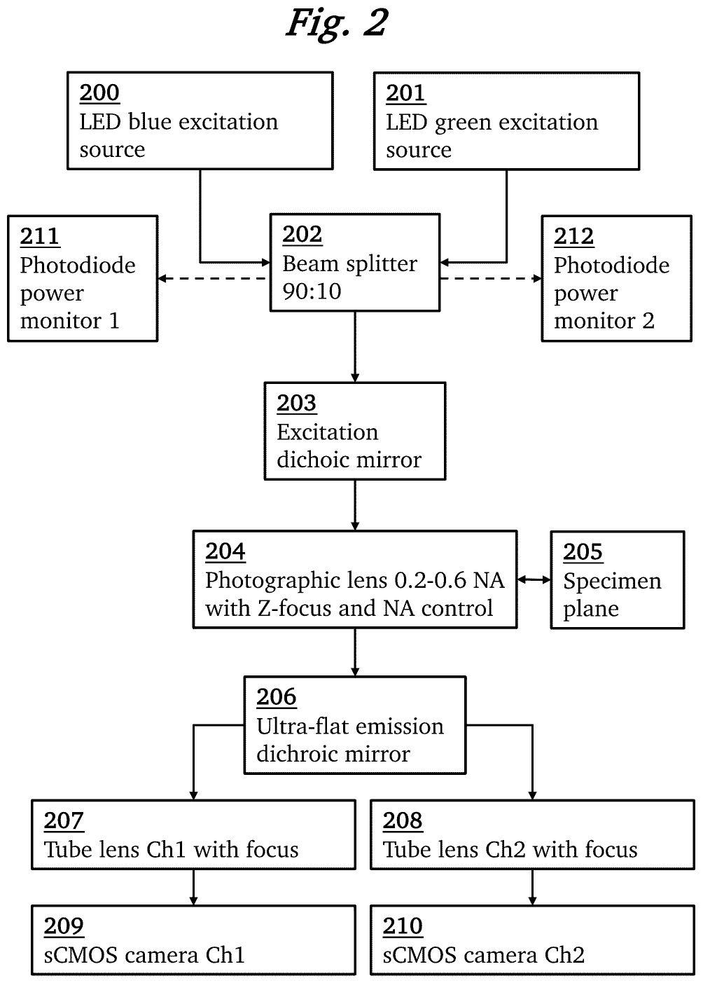

FIG. 2 illustrates the submodules within the system and their interconnections. The excitation sources 200 and 201, which represent a blue LED and a green LED, respectively, are equipped with respective bandpass filters that narrow the excitation light to the desired spectral range. These sources are collimated and combined through a beam splitter 202, preferably configured to split the light at a 90:10 ratio or less. The combined light is monitored by photodiodes 211 and 212, which serve as power monitors crucial for synchronization and noise reduction. From the beam splitter 202, the light enters the primary optical path, which may include an additional set of lenses and neutral density filters (not shown) for further control of the optical properties. The excitation dichroic mirror 203 redirects the light towards the main objective lens 204, which is preferably a photographic lens with a numerical aperture (NA) preferably between 0.2 and 0.6, and a field of view of at least 5 mm. This lens incorporates a motorized Z-focus mechanism for precise focusing and NA control. The main objective lens may be, for example, a Leica Noctilux-M 50 mm f/0.95 ASPH, Mitakon Zhongyi Speedmaster 50 mm f/0.95, TTArtisan 50 mm f/0.95,7Artisans Photoelectric 50 mm f/0.95, Brightin Star 50 mm f/0.95, Canon 50 mm f/0.95 “Dream Lens”, Zenit Zenitar 50 mm f/0.95, or SLR Magic HyperPrime 50 mm T0.95 variants. The collimated light reaches the specimen plane 205 for excitation. Emitted fluorescence is directed back through the system, interacting with an ultra-flat emission dichroic mirror 206 designed to ensure a high degree of optical flatness (less than 0.25λ peak-to-valley distortion) over a filter size of 70×100 mm. This mirror passes the fluorescence light, particularly optimized for green wavelengths common in biological imaging, and reflects it to maintain optical resolution. The light is subsequently split, directing it to channel 1 tube lens 207 and channel 2 tube lens 208, each including an internal focusing mechanism and bypass filters. These optical paths lead to sCMOS cameras 209 and 210, designated as channels 1 and 2, which capture the fluorescence images with high sensitivity and minimal noise. The tube lenses may be, for example, Canon EF 85 mm f/1.2 L II USM, Nikon NIKKOR Z 85 mm f/1.2 S, Canon RF 85 mm f/1.2 L USM and DS variant, Sony FE 85 mm f/1.4 GM, Sigma 85 mm f/1.4 DG DN Art, Zeiss Otus 85 mm f/1.4 ZF.2, Leica Noctilux-M 75 mm f/1.25 ASPH, Sigma 105 mm f/1.4 DG HSM Art, or Sony FE 135 mm f/1.8 GM.

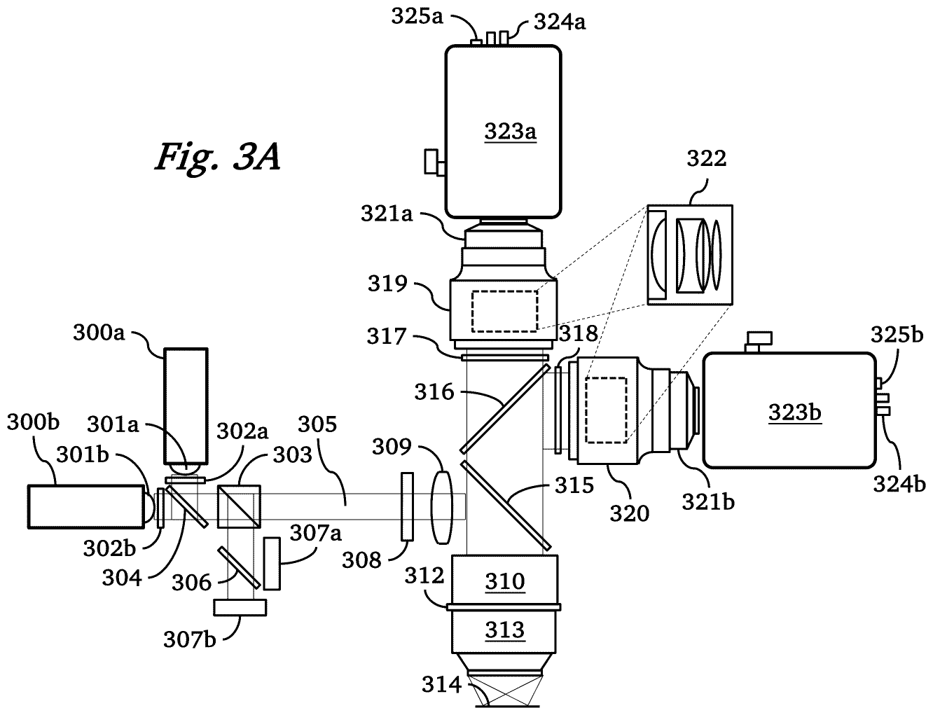

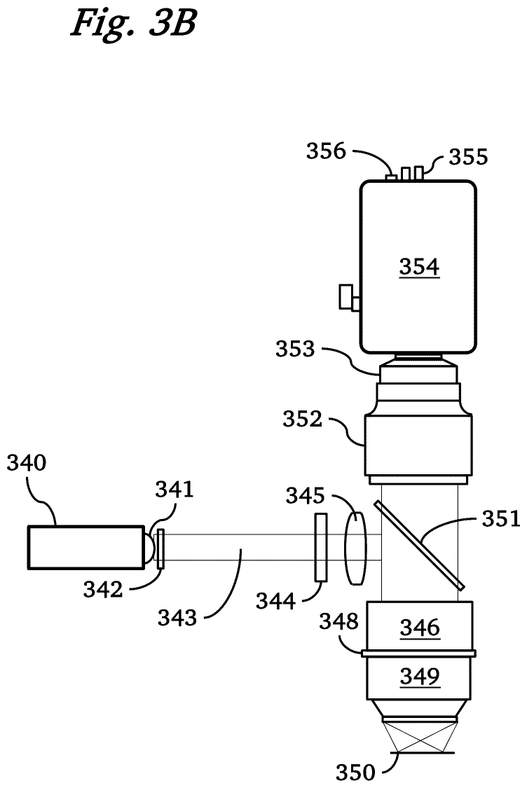

FIGS. 3A-3B depict two embodiments of the imaging system, with FIG. 3A illustrating a dual-channel setup and FIG. 3B showcasing a simplified single-channel version incorporating essential optical elements. In FIG. 3A, 300a and 300b represent high-power, ultra-low-noise LEDs serving as excitation sources, preferably with a root mean square (RMS) noise level of less than 0.1% of the DC component, defined as the steady-state intensity of the LED light under constant current operation, with 301a and 301b as collimators to refine the beam, and 302a and 302b as bandpass filters for spectral narrowing. The combined LED spectrum passes through a dichroic combiner 304, and optionally through a 90:10 beam splitter 303 for power monitoring. In one branch, the combined light proceeds to 306, a dichroic beam splitter, and 307a and 307b, photodiodes for real-time power monitoring. In the main branch, the combined light 305 continues through neutral density filters 308 and a lens group 309 designed for uniform illumination targeting the back aperture of the main objective lens 310, which has a numerical aperture of 0.2 to 0.6 and a field of view exceeding 5 mm, ideally over 7 mm. This lens ensures sub-50 micrometer lateral resolution, ideally under 7 micrometers. A focusing mechanism moves the lens 310 vertically, potentially motorized, while internal aperture control 312 modifies the depth of focus, and lens 313 fixes focus to infinity. The excitation dichroic mirror 315 reflects LED bands while passing emitted fluorescence from the specimen in the specimen plane 314, directed by ultra-flat dichroic 316 to single-band filters 317 and 318, isolating emission channels. Lenses 319 and 320 project images onto cameras with individual C-mount adapters 321a and 321b, each including focus adjustments for differential alignment as shown by inset 322, aiding chromatic correction and image alignment. CMOS cameras 323a and 323b, with at least 4 MP resolution and 6.5-micron pixels, offer 50% or higher quantum efficiency, ideally peaking above 85%. Data stream output ports 324a and 324b connect via CoaXPress cables, and ports 325a and 325b are the trigger interfaces.

FIG. 3B depicts a simplified configuration of an optical system optimized for applications such as calcium imaging, using indicators like the GCaMP family. The excitation source 340 is a high-power LED, followed by a collimator 341 that ensures proper beam alignment. The light then passes through a bypass filter 342 and continues as beam 343, the collimated light path. A neutral density filter 344 is positioned optionally to modulate light intensity, followed by a group of lenses 345 that can be interchanged with or without the neutral density filter to fine-tune illumination. The objective lens 346 functions similarly to the lenses depicted as 310 in FIG. 3A. The internal aperture control 348 and the fixed focusing mechanism 349 are analogs to components 312 and 313 in FIG. 3A, while 350 denotes the specimen plane, where a specimen such as a mouse brain labeled with GCaMP6 or GCaMP8 may be placed for imaging. The imaging system includes a simplified single mount for the lens, which may or may not include a lens control system. A dichroic mirror 351 reflects the light from LED 340 into objective lens 346 and transmits the fluorescence light from the objective lens 346. Dichroic mirror 351 is preferably a long-pass filter with 500 nm band of transmission and less then λ/4 of the transmission wavefront error. 352 is the tube lens, equivalent to 319 or 320 in FIG. 3A except the internal focusing mechanism is not required. 353 is the camera to lens mount, preferably C-mount, optionally equipped with a driver for the internal focus control. The camera 354 meets similar specifications as 323a and 323b in FIG. 3A, capable of sufficient sensitivity and resolution, though with lower bandwidth requirements due to the slower imaging rate of calcium imaging, typically 20 to 30 Hz. The data stream output port 355 interfaces the camera with processing hardware, while a trigger mechanism port 356 synchronizes the system, tailored for calcium imaging applications.

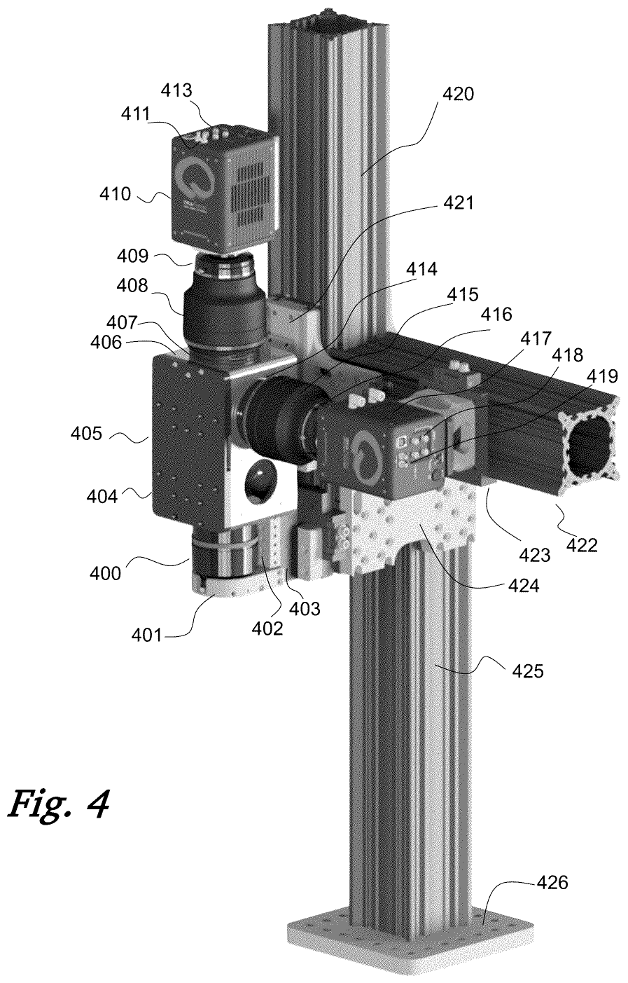

FIG. 4 shows a perspective view of an embodiment that aligns with the configurations described in FIG. 3A. The objective lens 400, as previously specified, is held by an adapter 401 securing the lens flange to the mechanical assembly. Component 402 is a mechanical part facilitating vertical positioning and objective replacement. The focusing mechanism 403 is a precision shutter stage with sub-micrometer accuracy. The cap 404 is designed to secure filter holders and accommodates individual dichroic and bandpass filters, inserting into the main filter cube 405. Position 406 indicates the placement of the upper portion of the filter module, adjacent to the ultra-flat dichroic mirror. The interconnecting part 407 links the filter cube and lens housing close to the bandpass filter location. The tube lens 408, a photographic type, connects to the C-mount adapter 409, which includes a lens driver, while 410 represents the camera. The data interface 411 uses CoaXPress for streaming, and 413 is the trigger interface. Tube lens 414, similar to 408, connects to the C-mount 416 for camera mounting, with 415 being an additional tube lens for the second channel. The second camera 417 can be mounted on a kinematic stage, with interfaces 418 and 419 serving as trigger and data stream connections, respectively. Structural component 420 is a 95 mm rail designed to dampen vibrations, while 421 is a custom connector securing the rails and providing overall stability. The horizontal rail 422 supports the second channel camera, while 423 is a carriage system adaptable for kinematic camera mounts. Part 424 interconnects the rails, extending the working distance between the main vertical post 425, which supports the entire structure. The base adapter 426 secures the vertical rail to the optical table, ensuring compatibility with the table's hole pattern for stable microscope operation.

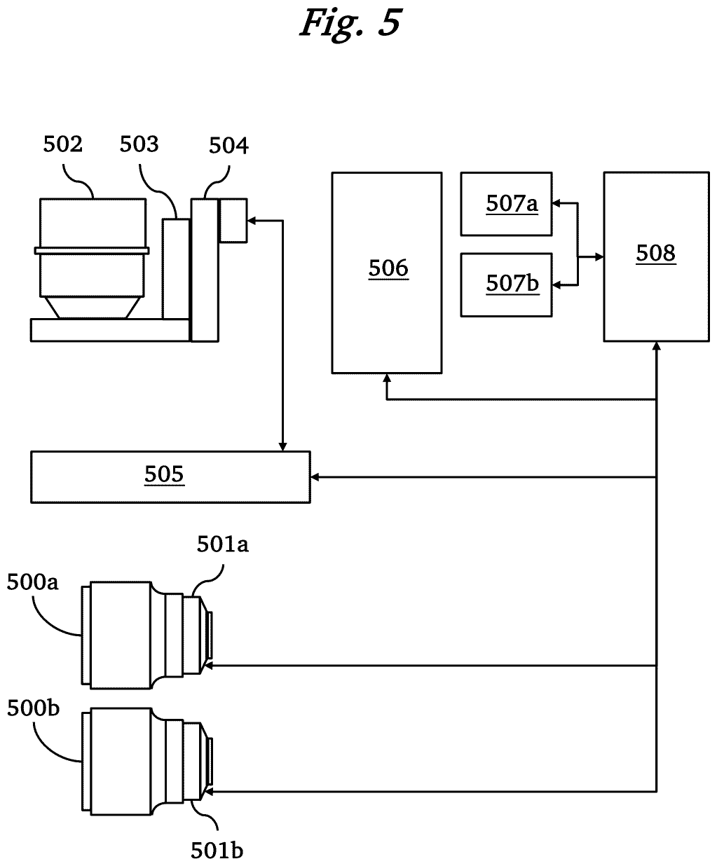

FIG. 5 illustrates the various controllers within an imaging system according to an embodiment of the invention. The equipped lenses are represented by 500a and 500b, and CMOS mounts 501a and 501b include ultrasonic motor (USM) controllers with USB interfaces, which are managed by the central control unit, a PC computer depicted as 508. The objective lens 502 is positioned on the mechanical holder 503 and is attached to a motorized stage with a resolution preferably exceeding 5 microns. The motorized stage 504 is operated via a driver 505, which is also linked to the computer 508 for coordinated control. The FPGA or microprocessor unit 506 is responsible for managing system components, including trigger mechanisms and LED control. The LED modules 507a and 507b facilitate digital-to-analog control for precise light modulation. All depicted modules, including the motorized stage, lens controllers, and LED drivers, are governed by the main controller unit 508, typically represented as a PC computer, to synchronize system operations effectively.

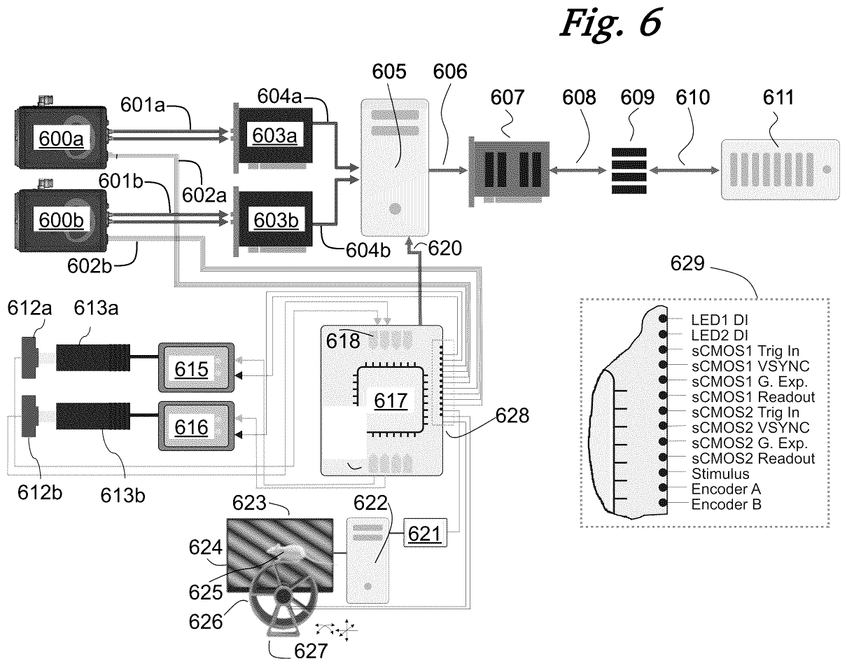

FIG. 6 depicts the signal flow and connectivity among system components in the imaging setup, starting with the two CMOS cameras 600a and 600b. These cameras transmit the primary data stream through CoaXPress interfaces 601a and 601b but could also be adapted for other interfaces like CameraLink. 602a and 602b represent the triggering interfaces facilitating camera synchronization. Frame grabbers are shown as 603a and 603b, connected via a PCI Express links 604a and 604b to a PC computer 605, which handles data processing. Another PCI Express link 606 connects the PC to 607, which represents a high-speed NVMe RAID array capable of sustaining data rates of at least 1.8 Gb/s. Alternatively, 607 could be a U.2 drive, such as those from Intel's lineup, interfacing through 608, a SATA connection, to the SSD RAID array 609. The processed data can be transmitted over network connections 610, with options for 10 Gb or 40 Gb Ethernet, to a network-attached storage (NAS) server 611.

The system also incorporates photodiodes 612a and 612b and LED sources 613a and 613b. Trigger ports 615 and 616 represent digital and analog connections, respectively, for precise control. The control unit 617, an FPGA or microprocessor, interfaces with both digital ports 618 and analog ports 619, facilitating system-wide management. Interface 620 connects the control unit with a PC via USB or network link, enabling communication and control.

Additionally, digital acquisition card 621 connects to a dedicated PC 622, used for experimental operations independent of the main imaging setup. The figure illustrates an application involving visual stimulation experiments with a live mouse 625 on a treadmill 626, controlled for position in four degrees of freedom using components like goniometers and translation stages. A monitor 623 displays patterns such as moving gratings or stripes 624 controlled by PC 622 to simulate visual stimuli for the mouse. Digital link connections 627 and 628, crucial for trigger and synchronization, are highlighted in inset 629, showing the layout for signal and timing management across the system.

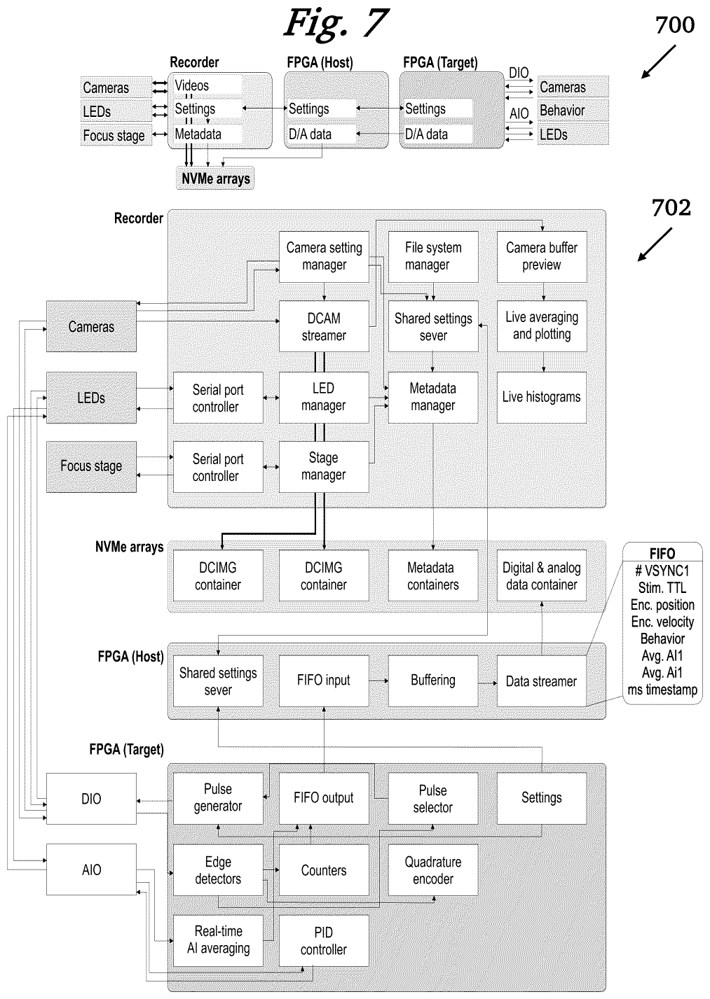

FIG. 7 shows the software architecture that governs the operation of the microscope, represented in panel 700 as a high-level overview of the control system managing cameras, LEDs, and the focusing stage. The main components include the recorder module, FPGA host, FPGA target, and the digital and analog interfaces that connect to cameras, behavior-monitoring modules, and LED controllers. The architecture emphasizes data handling, configuration, and operational synchronization.

Panel 702 in FIG. 7 provides a more detailed breakdown of the individual modules and their interconnections. This panel illustrates how data flows between cameras, LED drivers, the focus stage, and the recorder module. The camera setting manager oversees camera configurations, while the DCAM streamer facilitates video data streaming. LED and stage controllers manage the corresponding hardware via serial interfaces. The FPGA host manages settings and facilitates the high-speed transfer of data through FIFO (First In, First Out) buffers, which interface with NVMe arrays for data storage in containers dedicated to video (DCIMG), metadata, and digital/analog data. Additionally, the FPGA target handles pulse generation, edge detection, PID control for real-time averaging, and outputs for synchronization tasks. The FIFO module within the architecture provides high-speed data streaming from the FPGA to the computer, ensuring minimal latency during data transfer and real-time experiment feedback.

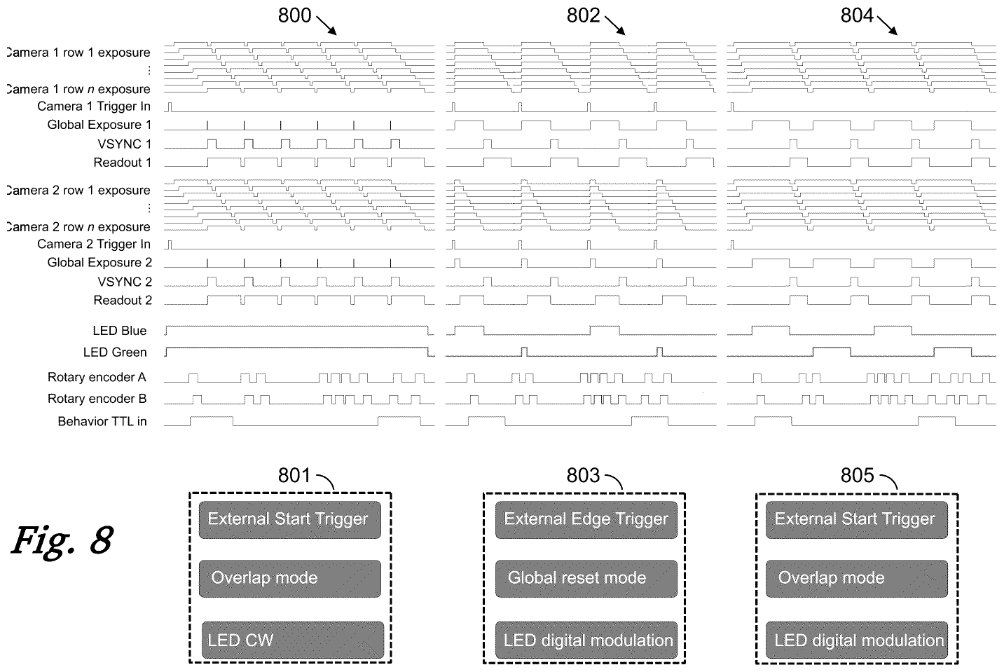

FIG. 8 presents timing diagrams for different operational modes involving two cameras and their synchronization. Panel 800 represents a basic operation mode where both Camera 1 and Camera 2 function with an external start trigger, allowing continuous operation of LEDs, summarized in the settings shown in 801. The exposure signals for both cameras display the rolling shutter effect, where each row is exposed sequentially with subsequent readout periods. The global exposure signals (Global Exposure 1 and Global Exposure 2) denote periods where all rows in each camera are exposed simultaneously. The VSYNC signals (VSYNC 1 and VSYNC 2) correspond to the end of the first row exposure for each camera, and the readout signals (Readout 1 and Readout 2) indicate the period when data is being read from the sensor. The LED Blue and LED Green signals are shown as continuous, synchronized with the exposure periods.

Panel 802, corresponding to the “2-GEVIs full exposure control” embodiment, illustrates a mode where both cameras operate with an external trigger and global reset mode, eliminating frame overlap. The exposure timing for Camera 1 and Camera 2 is independent, with each camera receiving its own trigger (Camera 1 Trigger In and Camera 2 Trigger In). The rolling shutter effect is visible, with sequential row exposures and synchronized readout. The LEDs alternate their activation based on the global exposure signals, controlled by an FPGA module that counts the rising edges of the Global Exposure 1 signal, ensuring precise synchronization. The operation is summarized in settings 803, which includes global reset mode and LED digital modulation.

Panel 804 corresponds to the “2-GEVIs balanced dynamic range” embodiment, showing detailed timing for synchronized operation of both cameras. In this mode, both cameras share the same trigger input, marked by Camera 1 Trigger In and Camera 2 Trigger In signals. The exposure and readout periods align for both cameras, with VSYNC signals marking the end of the first row exposure. The global exposure signals indicate full-frame exposure for each camera, synchronized to ensure consistent data acquisition. LED Blue and LED Green signals alternate between frames, providing balanced illumination, regulated by an FPGA module using the global exposure signal to toggle LED activation. This mode guarantees that LEDs alternate with each frame for even illumination and consistent dynamic range, summarized in settings 805, which highlights external start trigger and LED digital modulation as key features.

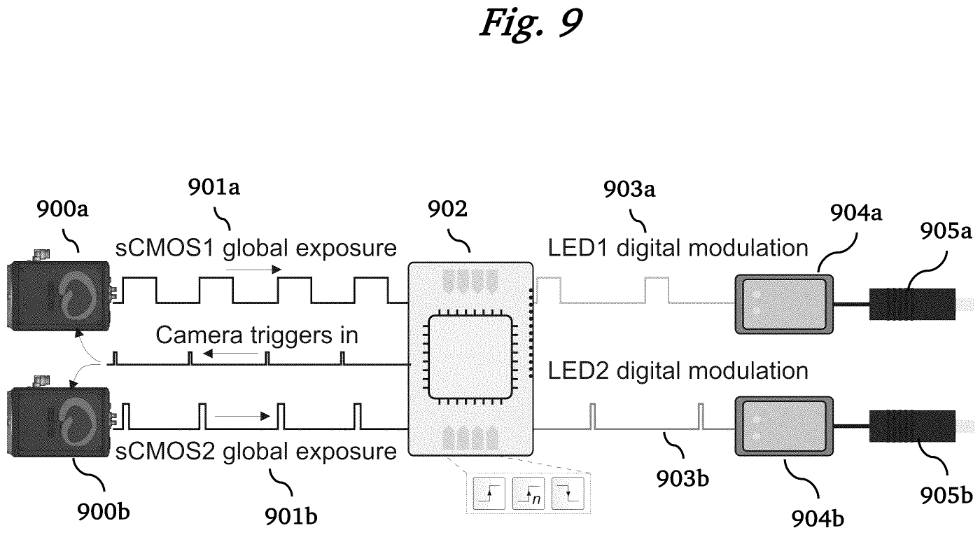

FIG. 9 illustrates the core logic used for synchronizing dual-camera operations through an FPGA or microprocessor unit 902. The schematic shows how global exposure signals 901a and 901b from sCMOS1 900a and sCMOS2 900b are managed to ensure synchronized triggering and interleaved operation of LEDs 905a and 905b. The global exposure signals 901a and 901b for both cameras are indicated, where sCMOS1 and sCMOS2 exposures are tracked. The camera triggers in sequence are depicted, demonstrating how the FPGA unit 902 counts the edges of the global exposure signals to initiate controlled timing for each frame. This logic enables the modulation of LED1 and LED2 digital signals 903a and 903b for precise alternation between light sources during imaging. LED1 and LED2 are managed by controllers 904a and 904b through digital modulation that corresponds to the camera frame timing, creating an interleaved activation scheme that prevents cross-talk and ensures optimal synchronization for multi-channel imaging. The setup ensures that each camera frame is illuminated by alternating LED sources, facilitating the capture of different spectral data in a coordinated sequence.

For a given frame rate (FPS), the following timing relationships are maintained:

Exposure time=T₀+T_{light}

FPS_{MAX}=1/T₀

FPS_{multispectral}=1/(T₀+T_{light})

where T₀ is the base exposure time and T_{light} is the illumination pulse duration.

The system generates a CLOCK_ALL signal through a logical AND operation between the exposure signals of the first and last sensor rows. This signal drives the pulsed light sources.

Synchronization of the pulsed excitation with the rolling shutter exposure of the camera is accomplished as follows: The control circuitry monitors the exposure timing signals from the camera, specifically the signals indicating the start of exposure of the first row and the end of exposure of the last row. A logical AND operation is performed between these exposure signals to generate a synchronization signal, referred to as the CLOCK_ALL signal. This signal is asserted only during the time period when all rows of the sensor are exposed simultaneously. The CLOCK_ALL signal is used to trigger the pulsed light sources. When CLOCK_ALL is asserted, a pulse generator circuit produces a pulse of specific duration to drive the light sources. For multi-spectral imaging with a single camera, multiple light sources are pulsed sequentially during each CLOCK_ALL period. Logic circuitry, such as counters or programmable logic devices, keeps track of the frame number and triggers the appropriate light source based on a predefined sequence. The pulse duration for each source can be independently adjusted to account for differences in brightness and spectral efficiency. By triggering the light sources only during the concurrent exposure period of all rows, the system ensures that each row receives the same illumination, eliminating any spatial gradients or banding artifacts. The short pulse duration also allows for faster frame rates and minimizes motion blur.

To maintain consistent signal-to-noise ratios and avoid over-illumination, the system incorporates an adaptive illumination control scheme. This involves adjusting the pulse intensity and duration based on the imaging parameters and sample characteristics. By dynamically calculating the required pulse duration based on the frame rate, concurrent exposure time, and the relative powers of pulsed and CW illumination, the system can ensure consistent illumination across different imaging conditions. The peak power of the pulsed sources can be adjusted to minimize the pulse duration while staying within the safe illumination limits for the sample. The system maintains consistent signal-to-noise ratios by managing light energy delivery: E_{light}=P_{light}*T_{light}. For pulsed operation compared to continuous wave (CW):

E_{light_CW}=P_{light_cw}*T₀

E_{light_pulsed}=P_{light_pulsed}*T_{light_pulsed}

Leading to:

P_{light_pulsed}=P_{light_CW}*T₀/T_{light_pulsed}.

The system achieves multi-spectral imaging by sequentially activating different excitation sources while maintaining high frame rates. The effective frame rate for n channels becomes FPS__{effective}=FPS__{MAX}/n.

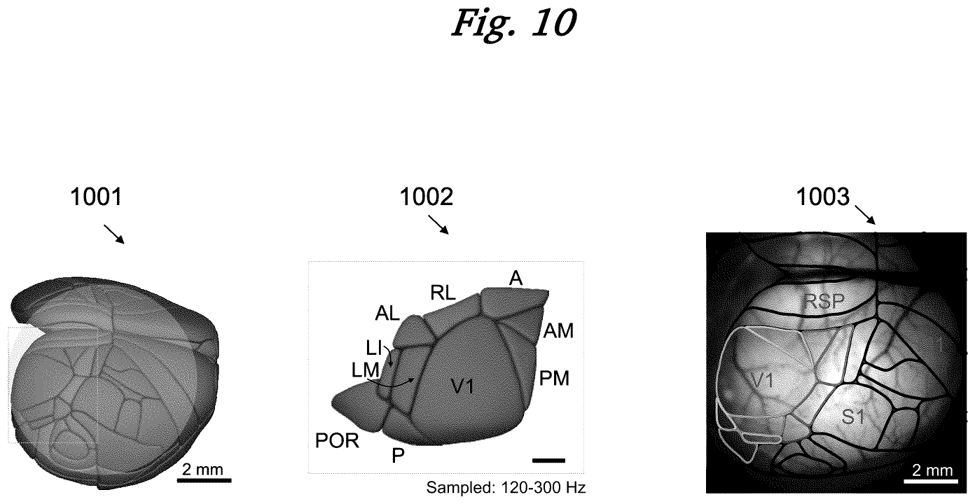

FIG. 10 showcases various fields of view attainable with the described imaging system. Panel 1001 presents an image of the mouse cortex illustrating the coverage of approximately 20 brain regions that can be imaged using a 7-8 mm circular implant, which matches the system's field of view. Panel 1002 provides an example of the primary and secondary visual cortex areas, demonstrating that these regions can be sampled at 300 Hz using the system's embodiment. Panel 1003 features an actual image captured by the system, highlighting that vignetting does not impede the imaging of extensive cortical areas, allowing clear visualization of regions such as the primary visual cortex (V1), primary somatosensory cortex (S1), and the retrosplenial cortex (RSP).

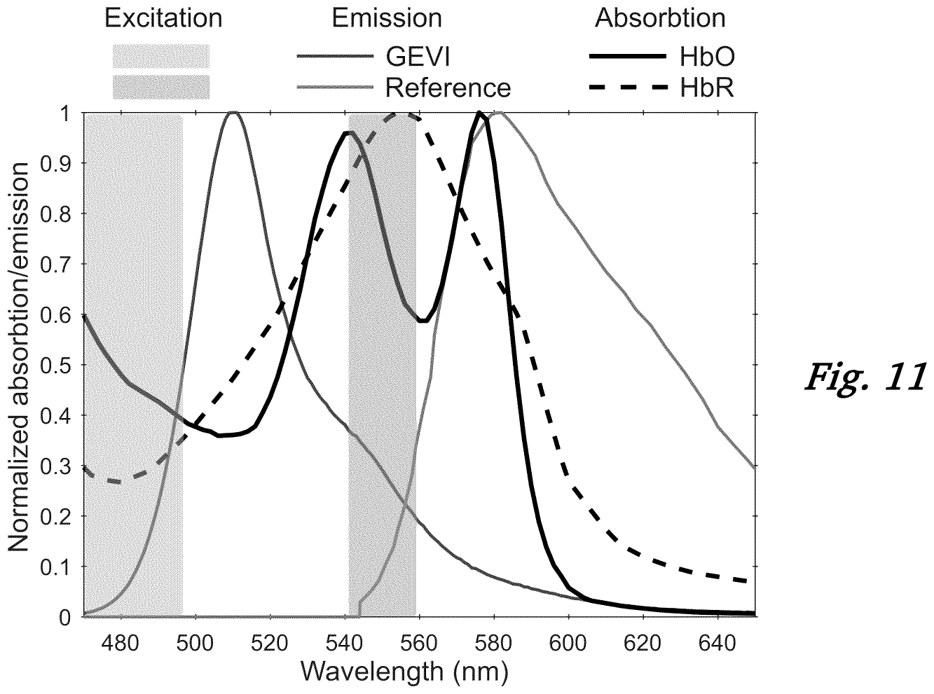

FIG. 11 is a graph that illustrates the strategic placement of excitation and emission bands in relation to the spectral properties of a genetically encoded voltage indicator (GEVI) and a reference signal. The graph shows how the selected excitation and emission bands align with the emission spectrum of the GEVI and the reference, enabling efficient fluorescence imaging. Additionally, the spectral absorption profiles of hemoglobin in its oxygenated (HbO) and deoxygenated (HbR) states are included for comparison. This highlights the system's capability to operate effectively within spectral regions that minimize interference from biological absorption, ensuring optimal signal-to-noise performance in applications such as voltage imaging and functional brain mapping.

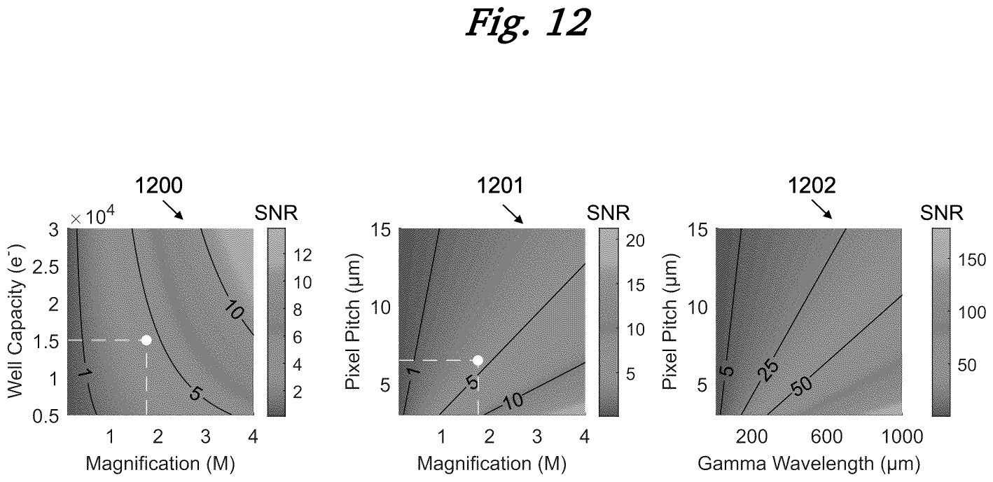

FIG. 12 depicts the characteristics of different mesoscope system families and highlights the specific embodiment represented by a white dot, which is particularly relevant for calcium imaging and voltage wave applications. Panel 1200 illustrates the relationship between signal-to-noise ratio (SNR), well capacity, and magnification, showing how these factors interact to optimize imaging performance. Panel 1201 displays the SNR as a function of pixel pitch and magnification, emphasizing the importance of selecting appropriate magnification and pixel pitch for high-SNR imaging. Panel 1202 presents the SNR in relation to pixel pitch and the theoretical wavelength of brain activity that can be observed, indicating that the selected system parameters enable the detection of high-SNR biological signals. The preferred magnifications, well capacities, and pixel pitches are shown to effectively support high-SNR imaging, crucial for capturing fine neural dynamics.

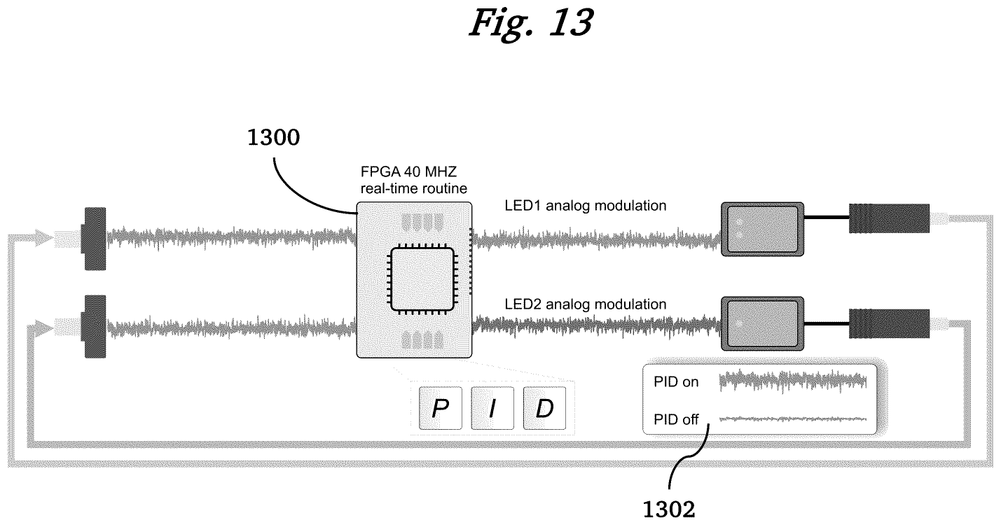

FIG. 13 demonstrates the system's capability for low-noise operation, a crucial aspect for many biological applications. By using an FPGA module 1300 running a 40 MHz real-time routine, the system employs proportional-integral-derivative (PID) control loops to actively reduce noise in the LED analog modulation. The read-out analog signal is fed back to the controller unit, which engages the PID loop to minimize fluctuations in the LED system. This embodiment showcases a significant reduction in noise up to 20 Hz, enhancing the system's performance for voltage imaging within relevant brainwave bands such as delta, theta, alpha, and low beta. The inset 1302 illustrates comparative noise levels with the PID control active (PID on) versus without it (PID off), highlighting the improved stability achieved through this method.

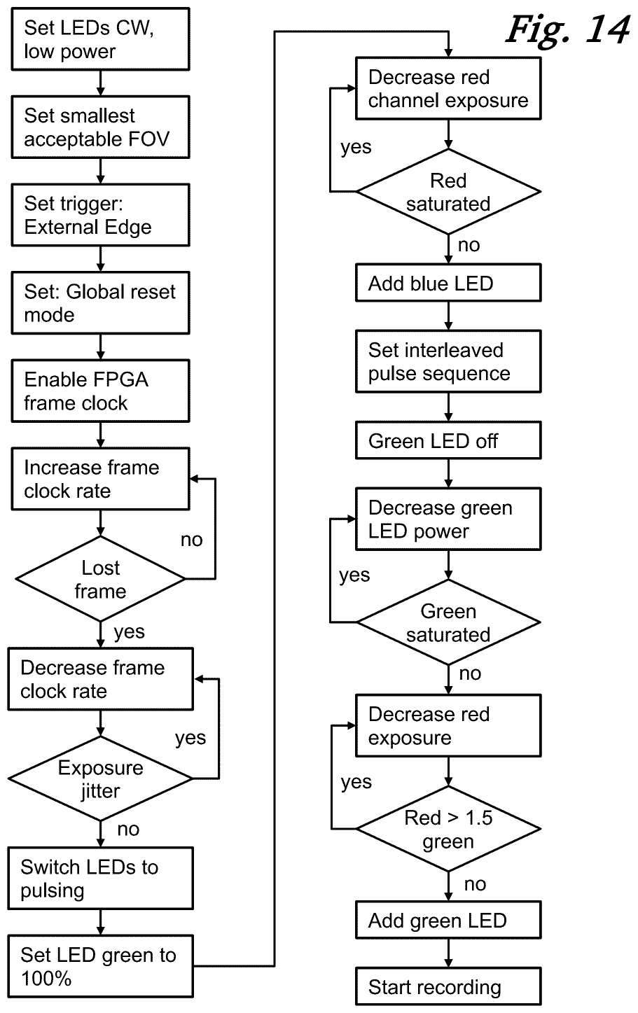

FIG. 14 is a flow diagram that outlines the procedural setup for imaging operations involving three channels using an alternating LED scheme. The process begins by setting the LEDs to continuous wave (CW) at low power and selecting the smallest acceptable field of view (FOV). The system is configured to use an external edge trigger and global reset mode, with the FPGA frame clock enabled. The frame clock rate is then incrementally increased, and the system checks for any lost frames. If a frame is lost, the frame clock rate is decreased. The process continues to assess whether there is exposure jitter; if not, the LEDs are switched to pulsing mode, with the green LED set to full power. The exposure for the red channel is decreased, and its saturation level is evaluated. If the red channel is saturated, the frame rate is adjusted; if not, the process moves forward. The next phase involves adding the blue LED and setting an interleaved pulse sequence, with the green LED temporarily turned off. The power of the green LED is reduced if the green channel is saturated; otherwise, red exposure is decreased. When the red channel's intensity is at least 1.5 times the green channel, the green LED is added, and the system begins recording. This flow ensures optimized multi-channel imaging with balanced illumination and minimal frame loss.

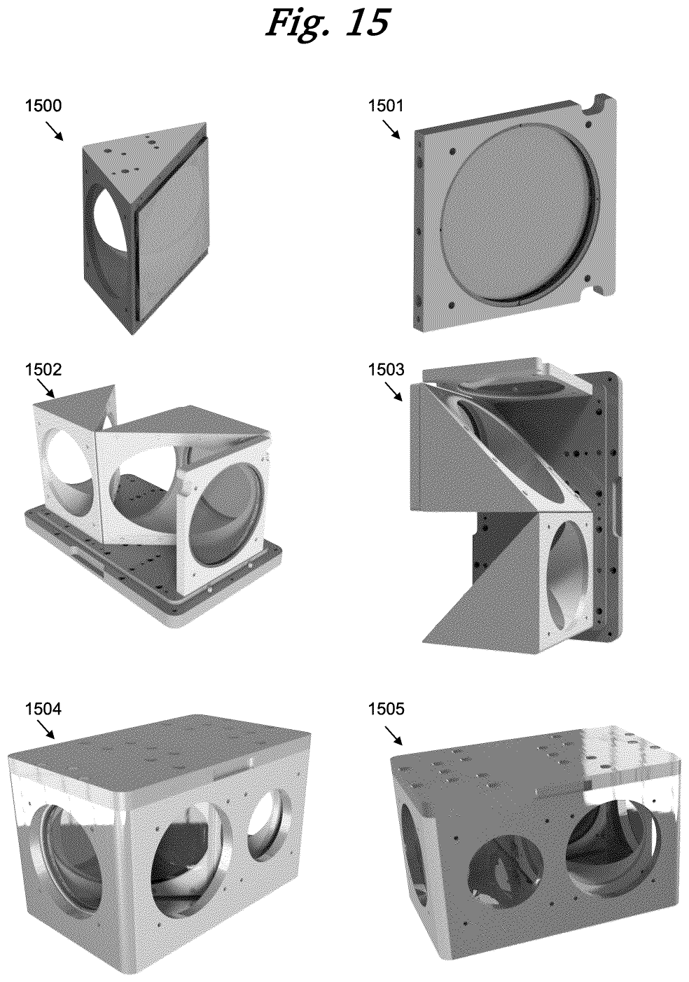

FIG. 15 shows perspective views of an embodiment of the holder for various optical elements integrated into the system. View 1500 shows the holder designed for the excitation dichroic mirror and the ultra-flat dichroic mirror, which splits the signal between the red and green emission channels. View 1501 displays the holder for a bandpass filter. Views 1502 and 1503 illustrate the placement of two dichroic mirrors and two single bandpass filters secured with magnetic inserts and double pins on a plate, forming an interchangeable insert for easy adjustment and reconfiguration. Views 1504 and 1505 showcase the complete system assembled as an aluminum enclosure, made from optical-grade aluminum alloy, such as 6061, known for its durability and precision in optical applications. The enclosure supports filters up to 70×100 mm in size, allowing for versatile setups with replaceable inserts to host large optical elements. Variants of this enclosure could include other high-grade aluminum alloys, such as 7075, for enhanced mechanical strength, or specialized anodized coatings for improved corrosion resistance and optical performance.

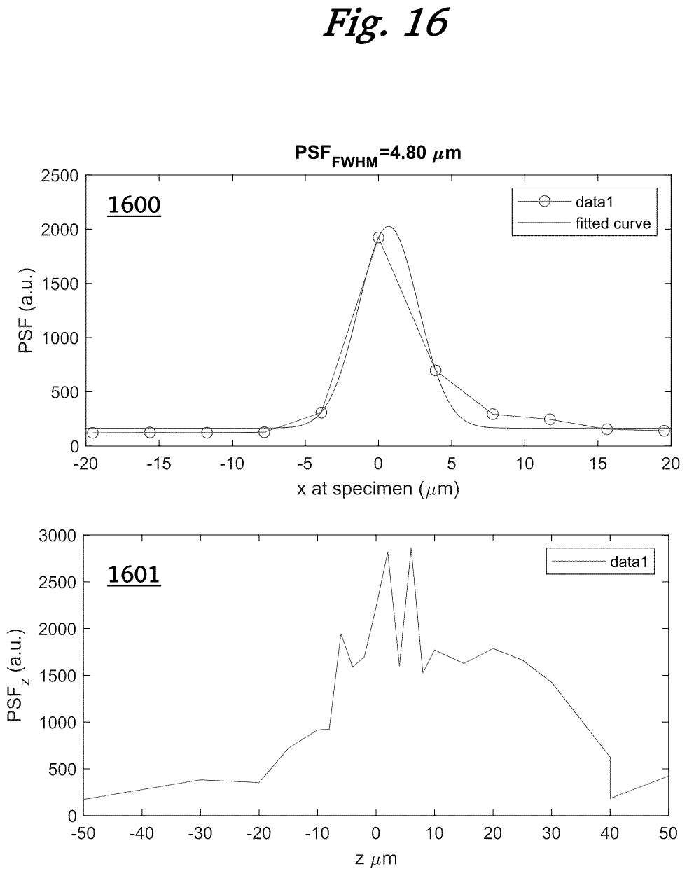

FIG. 16 are graphs that illustrate the resolution measurements of the imaging system. Graph 1600 displays the lateral point spread function (PSF), which has a full width at half maximum (FWHM) of approximately 4.8 micrometers, indicating the system's lateral resolution capability. Graph 1601 shows the axial PSF, providing insight into the system's depth resolution. Both panels highlight the precise imaging performance, demonstrating that the system achieves high resolution suitable for detailed biological imaging applications. The data in graph 1600 includes both experimental measurements (data points) and a fitted curve, while graph 1601 presents the axial distribution of the PSF to show the system's capacity for depth discrimination.

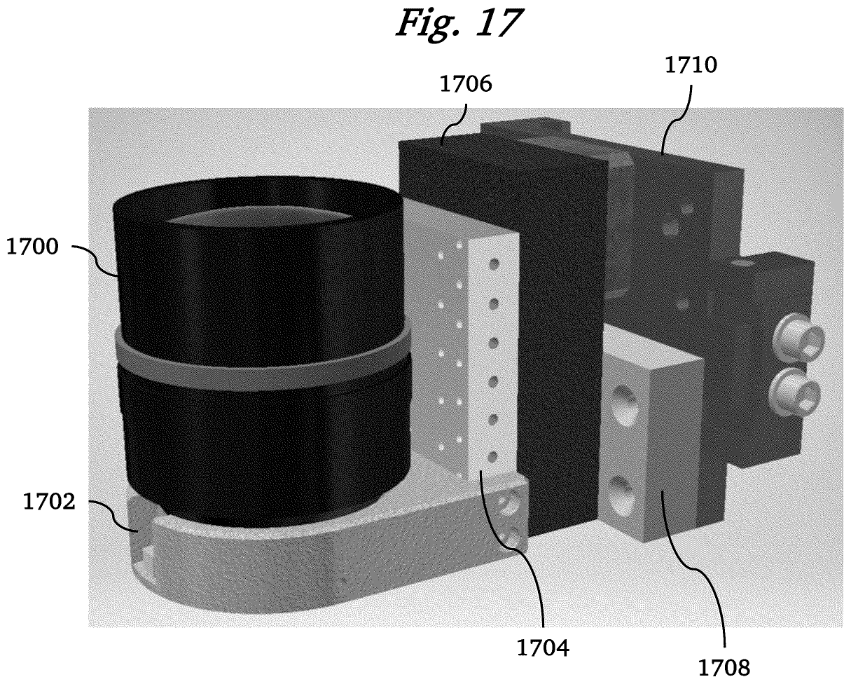

FIG. 17 illustrates the objective lens holder assembly according to an embodiment of the invention. This includes the objective lens itself 1700, the lower component of the objective holder 1702, and the interface part 1704 that connects the holder to the motorized stage 1706. The configuration also includes the mounting interface 1708 to the carriage 1710, which is attached to the system's rail structure, ensuring precise positioning and stability. The depicted structure highlights the integration of components that facilitate the secure attachment and alignment of the objective within the optical system.

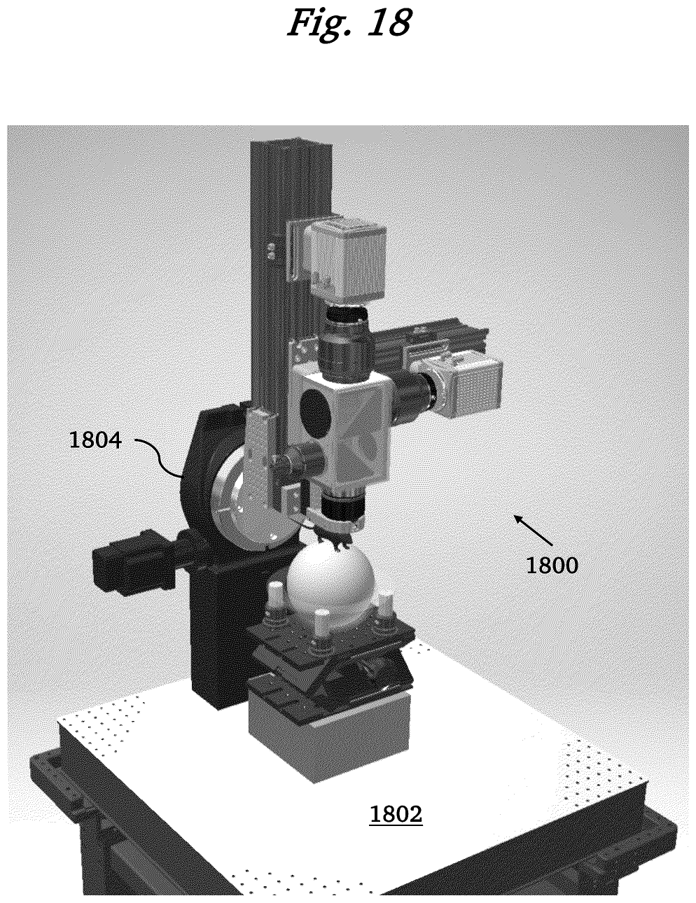

FIG. 18 illustrates an advanced embodiment of the system 1800 mounted on an optical table 1802 and supported by a heavy-duty rotary table 1804 that enables tilting of the entire imaging setup. The axis of rotation is strategically aligned with the center of the focal plane to maintain optimal focus and imaging quality during tilting. This configuration allows for side imaging of the mouse brain, enabling detailed studies of lateral brain structures. Additionally, due to its extensive field of view, this system can be adapted for side imaging in larger subjects, such as non-human primates and even humans. This capability expands the system's application to more complex and larger-scale neurological studies, where imaging from various angles is crucial for comprehensive data collection.

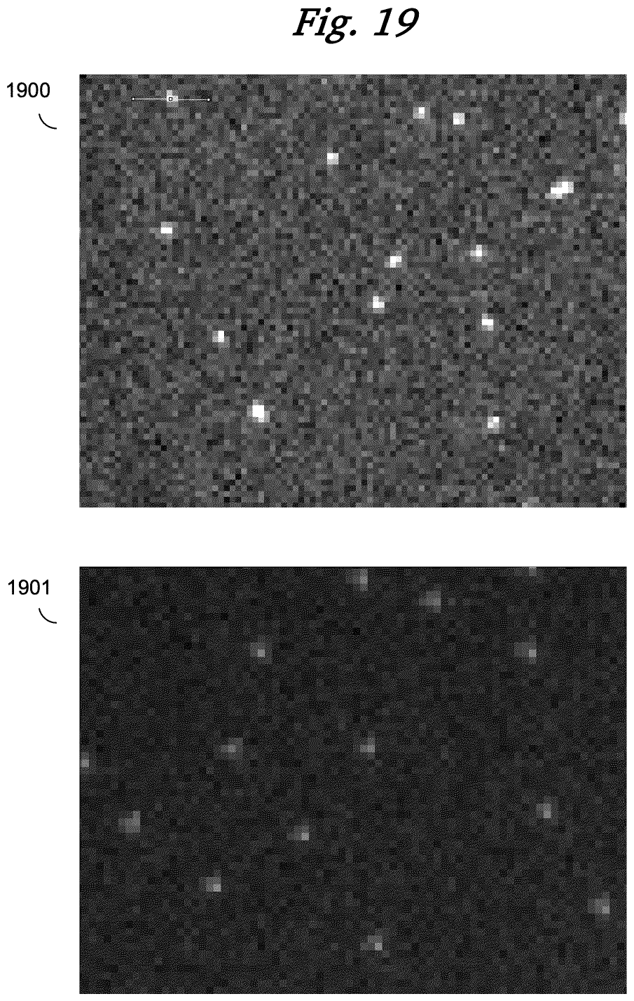

FIG. 19 displays raw imaging data of 1-micron diameter beads as captured by the camera sensor, illustrating pixel structures in both central and peripheral areas of the field of view. Panel 1900 shows the image of the beads located at the center of the field of view, highlighting the pixelated grid corresponding to the 6.5-micron pixel size of the Hamamatsu ORCA Fusion sCMOS camera. Panel 1901 depicts the same beads situated at the corner of the field of view, demonstrating how the image quality and pixel structure are maintained even at the edges of the sensor's coverage area. This comparison emphasizes the system's capacity for consistent resolution across the entire imaging field.

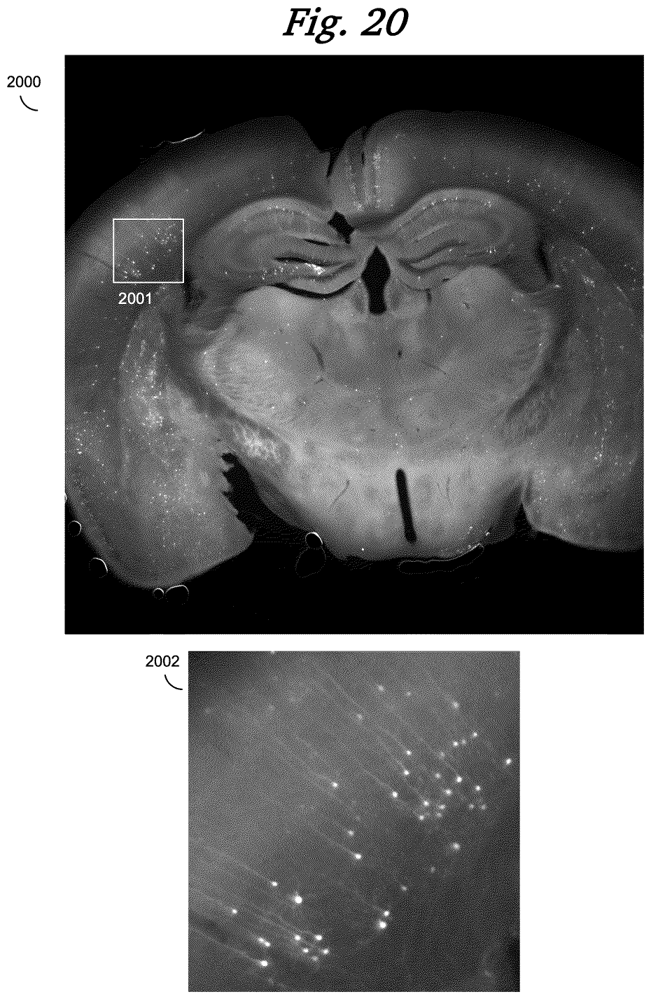

FIG. 20 displays example images of a mouse brain slice. Panel 2000 shows a coronal slice of the mouse brain, illustrating the overall structure. Region 2001 highlights a specific region within the coronal slice, which is further magnified in Panel 2002. This zoomed-in image reveals detailed views of pyramidal cells and their apical dendrites in the mouse cortex, demonstrating the high resolution and clarity achievable with the imaging system. These images emphasize the system's capability for capturing fine cellular structures crucial for neurological studies.

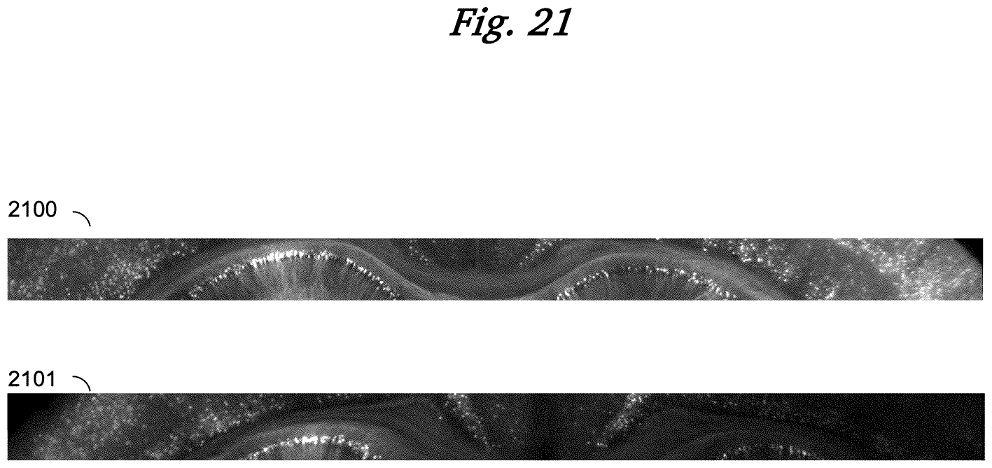

FIG. 21 presents coronal slices imaged at 1 kHz acquisition speed, showcasing the system's superior light collection efficiency and high signal-to-noise ratio. Panel 2100 depicts part of the hippocampal CA1 region, highlighting the clear visualization of pyramidal cells. Panel 2101 shows additional details, including a portion of the cortex. These high-speed imaging results emphasize the system's capability for capturing fast biological processes with excellent spatial resolution and clarity, demonstrating its suitability for detailed neural studies.

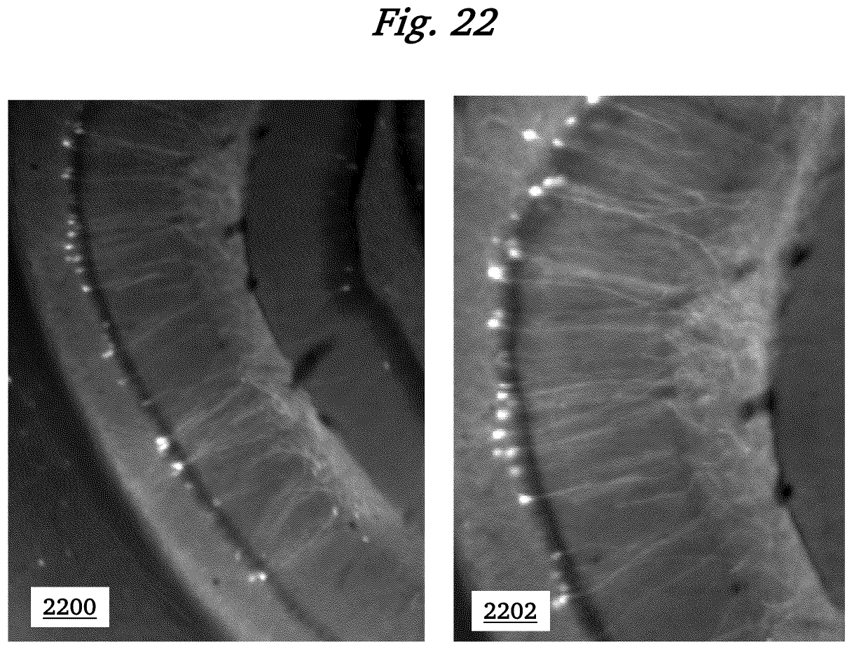

FIG. 22 displays additional examples of coronal brain slices illustrating various brain regions with excitatory and inhibitory cells labeled by green fluorescent proteins. Panel 2200 highlights a broad view showing networks of labeled cells, while the panel 2202 provides a closer view of specific cortical and hippocampal structures. These images emphasize the system's capability to capture detailed fluorescence labeling, enabling comprehensive visualization of cellular and subcellular structures across different brain regions. The clear resolution of both excitatory and inhibitory cells underlines the system's effectiveness in functional and structural imaging.

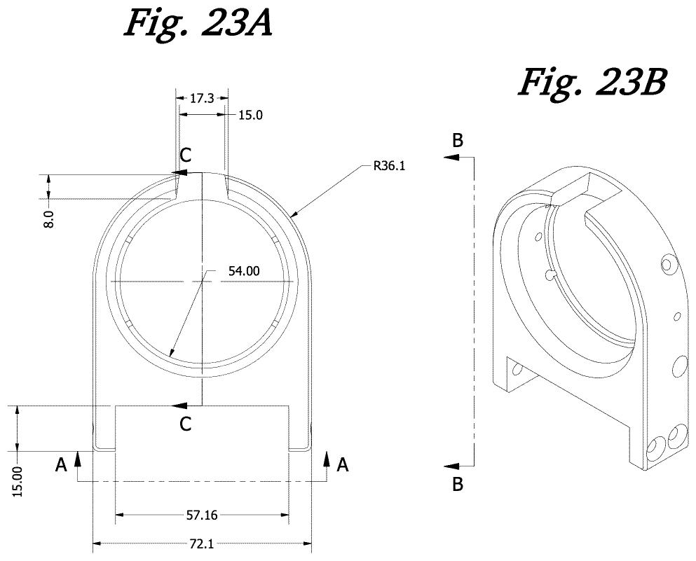

FIG. 23A and FIG. 23B are cross-sectional and perspective views that illustrate the mechanical design of the lens holder, specifically designed for a Leica Noctilux lens with an f-number of 0.95. This figure showcases detailed dimensional drawings and a 3D model, exemplifying the precision-engineered body used in the microscope system. The design demonstrates the practical application of custom mechanical manufacturing to ensure compatibility and secure mounting of high-performance optical components, highlighting the robust integration of optical and mechanical elements in the system.

In one example implementation, the system uses a Hamamatsu Orca Fusion camera (2048×2048 pixels, 100 Hz frame rate). The system is operated with the following parameters: Base exposure time (T₀)=10 ms, Global exposure window ≈10 μs, the period when all rows are exposed simultaneously. Prizmatix Ultra High Power LED with pulsed power=400 mW, Safe continuous power=20 mW, Results in T_{light_pulsed}=T₀/20. Thus, the pulse duration is 0.5 ms. Achieves FPS_{multispectral}=95.2% of FPS_{MAX}. To achieve a stationary and uniform pattern on the camera and eliminate spatiotemporal artifacts, the exposure of the first row of the sensor is nearly coincident with the exposure of the last row in the preceding frame.

Applications of the system include fluorescence microscopy, such as imaging multiple fluorophores labeling different cell types in biological specimens; high-speed biological imaging, capturing dynamic processes in living tissues with high temporal resolution; spectral unmixing, discriminating between fluorophores with overlapping emission spectra; and volumetric imaging, combined with axial scanning mechanisms for high-speed volumetric data acquisition.

1. An imaging system for fluorescence microscopy, comprising:
a) an optical illumination system with one or multiple light sources, configured to provide illumination across distinct spectral bands;
b) an objective lens with a numerical aperture of at least 0.2, providing a minimum field of view of 5 mm and a lateral optical resolution of 15 micrometers or better, configured to transmit the illumination to a specimen plane and detect fluorescence signals;
c) an optical image detection system with one or multiple cameras, each configured to capture images of the fluorescence signals at an acquisition speed of at least 5 Hz.

2. The imaging system of claim 1,
further comprising an optical transmission system having two dichroic mirrors;
wherein the optical illumination system is configured to illuminate a specimen with light pulses of distinct wavelength bands;
wherein the objective lens is configured to transmit the light pulses and collect spectrally distinct fluorescent light from the specimen;
wherein the optical image detection system has sCMOS cameras with rolling shutters synchronized with the light pulses to detect the spectrally distinct fluorescent light, wherein the light pulses and rolling shutters operate at a frequency of at least 5 Hz;
further comprising an integrated control and data handling system configured to collect, analyze, and store data streams generated from the sCMOS cameras.

3. The imaging system of claim 2, wherein the two dichroic mirrors comprise a dual-band dichroic mirror that reflects the light pulses into the objective lens and a short-pass dichroic mirror that splits the spectrally distinct fluorescent light to propagate to the sCMOS cameras.

4. The imaging system of claim 2, wherein the two dichroic mirrors have a flatness of at most 4λ peak-to-valley wavefront error at a predetermined operational wavelength λ, have substrates with a thickness of at least 2 mm, have wavefront distortion of less than 1λ across the surface, have dimensions of at least 50 mm×70 mm, and have coatings for wavelength-specific reflection and transmission.

5. The imaging system of claim 2, wherein the sCMOS cameras have a minimum sensor resolution of 4 MPx, a minimum frame rate of 80 fps at 4 MPx, a well capacity of at least 5000 electrons per pixel, and a read noise of 15 electrons or less.

6. The imaging system of claim 2, wherein the integrated control and data handling system comprises an FPGA generating trigger pulses synchronizing the rolling shutters of the multiple sCMOS cameras with the light pulses from the LEDs with a precision of at least 10 μs.

7. The imaging system of claim 2, wherein the light pulses are synchronized with a global exposure of the sCMOS cameras, where all the rows are imaged simultaneously.

8. The imaging system of claim 2, wherein the integrated control and data handling system is configured to save data on hard drives or to RAM at a rate of at least 800 Mb/s.

9. The imaging system of claim 1, wherein the one or multiple cameras are scientific-grade CMOS (sCMOS) cameras with a maximum readout noise of 8 electrons, a minimum acquisition rate of 30 Hz per 2000 rows, and a quantum efficiency of at least 60% at a central wavelength of an imaged fluorophore.

10. The imaging system of claim 1, wherein the optical image detection system comprises multiple tube lenses, each with focal lengths in the range of 70-135 mm, an f-number less than 5.6, or more preferably 1.2, and configured to provide independent focus adjustment for the cameras.

11. The imaging system of claim 1, wherein the objective lens provides a spatial precision of 15 μm or less across the minimum field of view, has a maximum aperture f-number of 1.2 or less, a focal length of at most 55 mm, and is designed to work with 35 mm films and full-size digital camera sensors while providing a working distance or flange focal distance of at least 2 mm.

12. The imaging system of claim 1, further comprising a focusing system comprising an ultrasound motor for focus adjustments, wherein the ultrasound motor integrates with photographic lens drivers, offering multiple speed modes and differential focusing.

13. The imaging system of claim 1, wherein the focusing mechanism comprises ultrasound motors.

14. The imaging system of claim 1, further comprising a rotational stage configured to allow tilting of the imaging system.

15. A system for synchronized multi-spectral imaging comprising:
a) at least one CMOS camera operating with a rolling shutter mechanism;
b) pulsed light sources emitting at different excitation wavelengths;
c) control circuitry generating a synchronization signal based on a temporal overlap of an exposure of first and last camera sensor rows, wherein the synchronization signal is used to trigger the pulsed light sources;
d) a module configured to sequentially activate the pulsed light sources based on pulse counts or predefined sequences;
e) spectral filters configured to separate excitation and emission wavelengths;
whereby the system enables multi-spectral imaging at a frame rate of at least 100 Hz for 2048 camera rows acquisition while eliminating spatiotemporal artifacts associated with rolling shutter operation.

16. The system of claim 15, wherein the control circuitry comprises a logical AND gate combining exposure signals from the first and last sensor rows to generate the synchronization signal.

17. The system of claim 15, wherein the control circuitry includes pulse counting mechanisms to control an activation sequence of the multiple light sources.

18. The system of claim 15, wherein the pulsed light sources are LEDs or lasers capable of less than 5 ms rise and fall times and adjustable pulse durations.

19. The system of claim 15, wherein an energy delivered per frame by each of the pulsed light sources is maintained equivalent to continuous wave illumination by adjusting pulse power and duration.

20. The system of claim 15 wherein the at least one CMOS camera comprises multiple CMOS cameras, each with independent exposure control and dedicated spectral emission filters, synchronized to capture different spectral channels simultaneously.

21. The system of claim 15, further comprising a synchronization mechanism configured to ensure that illumination occurs only during a time when all camera sensor rows are exposed simultaneously, thereby eliminating spatial gradients or banding artifacts.

22. The system of claim 15, further comprising a control module configured to adjust individual light source power levels while maintaining synchronization, to account for differences in fluorophore brightness and spectral efficiency.

23. The system of claim 15, wherein the control circuitry includes programmable logic devices or microcontrollers configured to implement variable pulse counting and spectral imaging sequences.
